(19) United States
(12) Patent Application Publication
(10) Pub. No.: US 2006/0052473 A1
(43) Pub. Date: Mar. 9, 2006

(54) Actinic ray curable ink-jet ink, image forming method and ink-jet recording apparatus

(75) Inventor: Toshiyuki Takabayashi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA MEDICAL & GRAPHIC, INC., Tokyo (JP)

(21) Appl. No.: 11/214,265

(22) Filed: Aug. 29, 2005

(30) Foreign Application Priority Data
Sep. 9, 2004 (JP) JP2004-262132

(51) Int. Cl. B29C 71/04

(52) U.S. Cl. 522/71

(57) ABSTRACT

An actinic ray curable ink-jet ink including a photoinitiator, a photopolymerizable composition, pigment particles, a dispersing agent having an amine value and an acid value, with the proviso that the amine value is larger than the acid value, wherein the pigment particles has an avergae particle diameter of from 0.08 to 0.25 μm and a number of the pigment particles having a particle diameter of not less than 1 μm is less than 6.0×10⁵/μl, the particle diameter being measured with a dynamic light scattering method.

This application is based on Japanese Patent Application No. 2004-262132 filed on Sep. 9, 2004, in Japanese Patent Office, the entire content of which is hereby incorporated by reference.

### TECHNICAL FIELD

The present invention relates to an actinic ray curable ink-jet ink which can stably produce a high-definition image on various recording materials. The present invention also relates to an image forming method and an ink-jet recording apparatus using the same ink-jet.

### BACKGROUND

Recently, the ink-jet recording has been applied to various printing fields such as photography, various kinds of printings, and especially printing such as marking and color filters because the ink-jet recording method can produce an image simply and at low cost.

Particularly, an image quality almost equal to a silver halide photograph can be obtained by means of: (i) a recording apparatus which enables to jet and to control a fine dot; (ii) an ink having improved properties of color reproduction area, durability, and jetting property; and (iii) an exclusive use sheet in which the absorptivity of the ink, coloring property of the coloring material, surface glossiness are greatly increased.

The increase of the image quality of today's ink-jet recording system is attained only when all of the recording apparatus, ink, and exclusive use sheet are present.

However, for the ink-jet system which requires exclusive use sheets, the kinds of the recording medium are limited and the cost increase of the recording medium becomes a problem. Accordingly, many trials have been made to record onto the recording medium different from the exclusive use sheet using the ink-jet method. They are, for example, a phase change ink-jet system using a solid wax ink at a room temperature, a solvent type ink-jet system using a quick dry type organic solvent as a main component, or a UV ink-jet system in which a cross-linkage is formed by an ultra violet (UV) ray after recording.

Among the above-mentioned trials, the UV ink-jet system has a lower degree of smell than the solvent type ink-jet system. The UV ink-jet system has been paid attention in recent years by considering its rapid drying property and a capability to record on a non ink-absorptive medium. Listed examples are shown in Patent Documents 1 to 7 described below.

In view of durability of formed images, in many cases, pigments are dispersed and employed as a colorant. Ink-jet ink which is cured by actinic ray such as ultraviolet radiation, forms a system in which adsorption between pigments and dispersing agents hardly occurs due to the presence of a polar group derived from a polymerizable group, even though it forms a solvent system. Compared to conventional paints, in ink-jet ink, pigment dispersing is an important problem. In the ink-jet recording system, droplets are ejected from tiny nozzles at a high rate. Consequently, when the resulting dispersion is unstable, ejection becomes unstable, resulting in major problems of ink-jet ink.

It has been widely known that in conventional actinic ray curable ink, pigments are dispersed employing basic dispersing agents. However, when the inventors of the present invention performed practical dispersion based on the above, it was not possible to achieve stable dispersion. Further, in Patent Documents 6, 7, 8 and 9, the number of coarse particles is specified. However, it was still not possible to achieve stable ejection of a non-water based actinic ray curable ink. Moreover, when, a content of the pigment is over 5.0 weight % based on the total weight of the ink, stable ejection is hardly achieved. This may cause a problem for forming an image of high resolution.

(Patent Document 1) Japanese Patent Publication Open to Public Inspection (hereafter it is called JP-A) No. 6-200204

(Patent Document 2) Japanese translation of PCT international application No. 2000-504778

(Patent Document 3) JP-A No. 2002-188025

(Patent Document 4) JP-A No. 2002-60463

(Patent Document 5) JP-A No. 2003-252979

(Patent Document 6) JP-A No. 11-140356

(Patent Document 7) JP-A No. 2002-204305

(Patent Document 8) JP-A No. 2004-59913

(Patent Document 9) JP-A No. 2005-187726

### SUMMARY

The present invention is attained to resolve the above-described problems. An object of the present invention is to provide an actinic ray curable ink-jet ink capable of stably producing a high-definition image of high quality with decreased bleeding and small wrinkle after being cured. An object of the present invention is also to provide an image forming method and an ink-jet recording apparatus using the same ink-jet.

The above-described object can be achieved by the following embodiments.

(1) An aspect of the present invention includes an actinic ray curable ink-jet ink comprising a photoinitiator, a photopolymerizable composition, pigment particles, a dispersing agent having an amine value and an acid value, with the proviso that the amine value is larger than the acid value,
wherein the pigment particles has an average particle diameter of from 0.08 to 0.25 μm and a number of the pigment particles having a particle diameter of not less than 1 μm is less than 6.0×10⁵ μl, the particle diameter being measured with a dynamic light scattering method.

(2) Another aspect of the present invention includes an actinic ray curable ink-jet ink,
wherein the pigment particles are subjected to a surface treatment and a content of the dispersing agent is 35 to 65 weight % based on the total weight of the pigment particles.

(3) Another aspect of the present invention includes an actinic ray curable ink-jet ink,
wherein the photopolymerizable composition comprises an oxirane compound.

(4) Another aspect of the present invention includes an actinic ray curable ink-jet ink,
wherein the photopolymerizable composition comprises:
   (a) an oxetane compound in an amount of 30 to 95 weight %;
   (b) an oxirane compound in an amount of 5 to 70 weight %; and
   (c) a vinyl ether compound in an amount of 0 to 40 weight %, each weight % of (a), (b) and (c) being based on the total weight of the photopolymerizable composition.

(5) Another aspect of the present invention includes an actinic ray curable ink-jet ink,
wherein the actinic ray curable ink-jet ink has a viscosity of 7 to 50 mPa·s at 25° C.

(6). Another aspect of the present invention includes an actinic ray curable ink-jet ink,
wherein the pigment has an amine value and an acid value, with the proviso that the amine value is larger than the acid value.

(7) Another aspect of the present invention includes an actinic ray curable ink-jet ink,
wherein a content of the pigment particles is 0.5 to 4.8 weight % based on the total weight of the actinic ray curable ink-jet ink.

(8) Another aspect of the present invention includes a method of forming an image comprising the steps of:
ejecting droplets of the actinic ray curable ink-jet ink of claim 1 from a plurality of nozzles of an ink-jet recording head onto a recording material to form an image; and
irradiating the formed image with actinic rays to cure the image,
wherein the irradiating step is carried out between 0.001 and 1 second after the ejected droplets reach the recording material.

(9) Another aspect of the present invention includes a method of forming an image comprising the steps of:
ejecting droplets of the actinic ray curable ink-jet ink of the above-described item 1 from a plurality of nozzles of an ink-jet recording head onto a recording material to form an image; and
irradiating the formed image with actinic rays to cure the image,
wherein a thickness of the cured image is in the range of 2 to 25 μm.

(10) Another aspect of the present invention includes a method of forming an image comprising the steps of:
ejecting droplets of the actinic ray curable ink-jet ink of the above-described item 1 from a plurality of nozzles of an ink-jet recording head onto a recording material to form an image; and
irradiating the formed image with actinic rays to cure the image,
wherein the droplets of the actinic ray curable ink-jet ink ejected from each nozzle of the ink-jet recording head have a volume of 2 to 15 pl.

(11) Another aspect of the present invention includes a method of forming an image comprising the steps of:
ejecting droplets of the actinic ray curable ink-jet ink of the above-described item 1 from a plurality of nozzles of an ink-jet recording head onto a recording material to form an image; and
irradiating the formed image with actinic rays to cure the image,
wherein the ink-jet recording head is a line head.

(12) Another aspect of the present invention includes an ink-jet recording apparatus for carrying out the image forming method of the above-described items 6-9,
wherein the actinic ray curable ink-jet ink and the ink-jet recording head are heated at 35 to 100° C. before ejecting the actinic ray curable ink-jet ink from a plurality of nozzles of the ink-jet recording head.

According to the present invention, it was possible to provide an actinic ray curable ink-jet ink capable of very stable recording, under excellent reproducibility, highly detailed images which exhibit excellent text quality without color mixture, an image forming method, and an ink-jet recordings apparatus.

### BRIEF DESCRIPTION OF THE DRAWINGS

FIG. 1 is a front view showing one example of the structure of the major section of the ink-jet recording apparatus of the present invention.

FIG. 2 is a top view showing another example of the major section of the ink-jet recording apparatus of the present invention.

### DESCRIPTION OF THE PREFERRED EMBODIMENTS

The present invention will now be detailed. The inventors of the present invention conducted diligent investigation and discovered that a stable pigment dispersion was achieved employing dispersing agents in which the acid value was greater than the amine value, and ejection was significantly stabilized in such a manner that the average diameter of particles incorporated in the resulting actinic ray curable ink (hereinafter also referred simply to as ink) was maintained at 0.08-0.25 μm and the number of coarse particles at a particle diameter of at least 1 μm was controlled to be less than 6.0×10⁵/μl. Cases, in which the volume of the ink droplets ejected from each nozzle of the recording head was as small as 2-15 pl, were particularly, effective.

It was also discovered that in the case of a cationically photopolymerizable system in which photolytically acid generating agents as a photoinitiator, as well as epoxy compounds and/or oxetane compounds as photopolymerizable compounds were employed, the above ejection stability was further improved.

It is possible to determine the acid value and the amine value in the present invention, employing potentiometric titration. It is possible to determine the above values employing the method described, for example, in Shikizai Kyokaishi (Journal of the Japan Society of Colour Material), 61, [12] 692-698 (1988). When a plurality of pigments and dispersing agents is used, the above values may be employed as a weight average.

In the present invention, the acid value of dispersing agents is greater than the amine value of the same, and the difference is preferably 1-30 mg/gKOH. When the above difference is less than 1 mg/gKOH, no effect is obtained, while when it exceeds 30 mg/gKOH, it is a major concern that a thermal reaction occurs resulting in curing. Employed as dispersing agents may be those of a low or high molecular weight, but those of a high molecular weight are preferred. Listed as specific examples of the preferred dispersing agents are AJISPER PB824, AJISPER PB822, and AJISPER PB821, all products of Ajinomoto Fine Techno Co., however, the present invention is not limited thereto.

The pigment used in the present invention is preferably subjected a surface treatment with an acid or a base. A content of the dispersing agent is preferably from 35 to 65 weight % based on the total weight of the pigment particles.

When this value is less than 35 weight %, the dispersing may not sufficiently adsorbed to the total surface of the pigment.

When this value is over 65 weight %, an excessive amount of the dispersing agent may remain free in the ink, which would cause incomplete polymerization.

It is preferable that the amine value of pigments is greater than the acid value of the same. The difference is preferably 1-10 mg/gKOH. When the difference is less than 1 mg/gKOH, no resulting effect is obtain, while at least 10 mg/g difference is not preferred due to an increase in cost for the need of an excessively performed basic treatment.

When the amine value is over 10 mg/g KOH, a repeated basic treatment is required, which will yield increase of cost as well as incomplete polymerization.

Specific examples of pigments in which the amine value is greater than the acid value are listed below, however the present invention is not limited thereto: C.I. Pigment Yellow 1, 2, 3, 12, 13, 14, 16, 17, 73, 74, 75, 81, 83, 87, 93, 97, 98, 109, 114, 120, 128, 129, 138, 151, and 154; C.I. Pigment Red 5, 7, 12, 22, 38, 48:1, 48:2, 48:4, 49:1, 53:1, 57:1, 63:1, 101, 112, 122, 123, 144, 146, 168, 184, 185, and 202; C.I. Pigment Violet 19 and 23; C.I. Pigments Blue 1, 2, 3, 15:1, 15:2, 15:3, 15:4, 18, 22, 27, 29, and 60; C.I. Pigment Green 7; C.I. Pigment White 6, 18, and 21; and Pigment Black 7.

For the dispersion of the pigment, for example, a ball mill, sand mill, attritor mill, roll mill, agitator, Henshel mixer, colloid mill, ultrasonic homogenizer, pearl mill, wet jet mill, or paint shaker can be used. As dispersion medium, the dispersion is conducted by using the solvent or polymerization compound, however, it is preferable that the actinic ray curing type ink used in the present invention contains-no solvent because, without solvent, it is reacted and cured just after the ink impacts. When the solvent remains on the cured image, a problem of the deterioration of the solvent resistance, and the problem of VOC derived from the remaining solvent is generated. Accordingly, it is preferable in the dispersion property that the dispersion medium is not the solvent, but the polymerization compounds, and in them, the monomer whose viscosity is lowest is selected.

In the present invention, it is required that after forming ink, the average diameter of pigment particles is controlled to be 0.08-0.25 μm, while the number of coarse particles of a diameter of at least 1 μm is controlled to be less than 6.0×10⁵ μl. The average particle diameter, as described in the present invention, refers to the volume average particle diameter value determined employing a particle diameter measuring instrument (employing a dynamic optical scattering method) such as ZETA SIZER NANO SERIES, produced by Malvern Instruments, Ltd. When the average particle diameter is less than 0.08 μm, particle diameter variation after storage results in problems, while when it exceeds 0.25 μm, retention in the ink flow channel in the recording head becomes problematic. Further, the number of coarse particles of a diameter of at least 1 μm in the present invention is determined as follows. The number of coarse particles of a diameter at least 1 μm in the definite area of the layer which was prepared by applying the ink onto a support to result in a thickness of 3 μm employing a bar coater, was counted employing an optical microscope of 5000 times enlargement, and the resulting number was converted to the number per μl of the ink. It is possible to appropriately control the average particle diameter of pigments, selecting the types of pigments, the types of dispersing agents, and dispersing conditions, while it is possible to control the number of coarse particles by suitably selecting filtration conditions (selection of filters, multiple steps of filtration or presence of centrifugal separation).

The content of pigment in the ink is preferably from 0.5 to 4.8 weight %. It was found that stable ink ejection is hardly achieved with an ink containing an pigment having a content of more than 4.8 weight %. When a volume of a ink droplet is from 2 to 15 pl, it was found that the controlling the content of pigment in the ink to be less than 4.8 weight % is effective to achieve stable ink ejection using an ink having a controlled average particle size and a controlled number of large size particles. When the content of pigment in the ink to be less than 0.5 weight %, color density becomes to small for practical use as an ink.

Further, in the present invention, in order to enhance curability and ejection stability, it is preferable to incorporate at least one type of compound having an oxirane group.

Employed as photopolymerizable compounds may be various types of cationically polymerizable monomers known in the art. Listed are, for example, epoxy compounds, vinyl ether compounds and oxetane compounds, described, for example, in JP-A Nos. 6-9714, 2001-31892, 2001-40068, 2001-55507, 2001-310938, 2001-310937, and 2001-220526.

Listed examples of an epoxy compound are the following aromatic epoxides, alicyclic epoxides and aliphatic epoxides.

Preferred examples of an aromatic epoxide are, polyhydric phenol having at least one aromatic nucleus or di or poly glycidyl ether which is produced by the reaction of its alkylene oxide additive body and epichloro-hydrin, and for example, bisphenol A or di or poly glycidyl ether of its alkylene oxide additive body, and novolak type epoxy resin are listed. Herein, as the alkylene oxide, ethylene oxide and propylene oxide are listed.

As an alicyclic epoxide, compounds including cyclohexene oxide or cyclopentene oxide obtained when compounds having at least one cyclo alkane ring such as cyclo hexene or cyclo pentene ring are epoxidized by an adequate oxidation agent such as hydrogen peroxide or peroxy acid are preferable.

As a preferable aliphatic epoxide, there are listed as follows: aliphatic polyhydric alcohol or di or poly glycidyl ether of its alkylene oxide additive body, and as its representative example, di-glycidyl ether of ethylene glycol, di-glycidyl ether of propylene glycol, or di-glycidyl ether of alkylene glycol such as di-glycidyl ether of 1, 6 hexane diol, poly-glycidyl ether of polyhydric alcohol such as di or tri-glycidyl ether of glycerin or its alkylene oxide additive body, di-glycidyl ether of poly-alkylene glycol such as di-glycidyl ether of polyethylene glycol or its alkylene oxide additive body, di-glycidyl ether of poly-alkylene glycol such as di-glycidyl ether of polypropylene glycol or its alkylene oxide additive body. Herein, as an alkylene oxide, ethylene oxide and propylene oxide are listed.

Of these epoxides, upon considering rapid curing properties, preferred are aromatic epoxides as well as alicyclic epoxides, and particularly preferred are the alicyclic ones. In the present invention, the above epoxides may be employed singly or in suitable combinations of at least two types.

Further, in the present invention, in view of safety such as AMES test as well as sensitizing property, it is preferable that as epoxy compounds having an oxirane group, either an epoxidized fatty acid ester or an epoxidized fatty acid glyceride is incorporated.

Epoxidized fatty acid esters as well as epoxidized fatty acid glycerides are employed without any particular limitation as long as epoxy groups are introduced into the fatty acids or fatty acid glycerides. Employed as epoxidized fatty acid esters are: epoxidized oleic acid esters, methyl epoxystearate, butyl epoxystearate, and octyl epoxystearate. Employed as epoxidized fatty acid glycerides which are prepared by epoxidized soybean oil, linseed oil, or castor oil are epoxidized soybean oil, epoxidized linseed oil, and epoxidized castor oil.

Further, the ink of the present invention preferably contains 30-95 percent by weight of at least one of the oxetane compounds, 5-70 percent by weight of at least one of the compounds having a oxirane group, and 0-40 percent by weight of at least one of the vinyl ether compounds.

Examples of oxetane compounds used for the present invention are disclosed in JP-A Nos. 2001-220526 and 2001-310937.

Examples of such vinyl ether compounds include di- or trivinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexane dimethanol divinyl ether, trimetnylolpropane trivinyl ether, as well as monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexane dimethanol monovinyl ether, n-propyl vinyl ether, isopropyl vinyl ether, isopropenyl ether-O-propylene carbonate, dodecyl vinyl ether, diethylene glycol monovinyl ether, or octadecyl vinyl ether.

Of these vinyl ether compounds, in order to achieve high curability, high adhesion, and high surface hardness, preferred are di- or trivinyl ether compounds, and divinyl ether compounds are particularly preferred. In the present invention, the above vinyl ether compounds may be employed individually or in appropriate combinations of at least two types.

Further, in the present invention, it is also possible to employ radically polymerizable compounds. Employed as radically polymerizable compounds may be any of the (meth)acrylate monomers and/or oligomers, known in the art.

Examples of the above compounds include mono-functional monomers such as isoamyl acrylate, stearyl acrylate, lauryl acrylate, octyl acrylate, decyl acrylate, isomyristyl acrylate, isostearyl acrylate, 2-ethylhexyldiglycol acrylate, 2-hydroxybutyl acrylate, 2-acryloyloxethylhexahydrophthalic acid, butoxyethyl acrylate, ethoxydiethylene glycol acrylate, methoxydiethylene glycol acrylate, methoxypolyethylene glycol acrylate, methoxypropylene glycol acrylate, phenoxyethyl acrylate, tetrahydrofurfuryl acrylate, isobornyl acrylate, 2-hydroxyethtl acrylate, 2-hyroxypropyl acrylate, 2-hydroxy-3-phenoxypropyl acrylate, 2-acryolyoxyethyl succinate, 2-acryloyloxyethyl phthalate, 2-acryloloxyethyl-2-hydroxyethyl phthalate, lactone-modified flexible acrylate, or t-butylcyclohexyl acrylate; bi-functional monomers such as triethylene glycol diacrylate, tetraethylene glycol diacrylate, polyethylene glycol diacrylate, tripropylene glycol diacrylate, polypropylene glycol diacrylate, 1,4-butanediol diacrylate, 1,6-hexanediol diacrylate, 1,9-nonanediol diacrylate, neopentyl diacrylate, dimethylol-tricyclodecane diacrylate, EO addition product diacrylate of bisphenol A, PO addition product diacrylate of bisphenol A, hydroxypivalic acid neopentylglycol diacrylate, or polytetramethylene glycol diacrylate; tri- or multi-functional monomers such as trimethylolpropane triacrylate, EO modified trimethylolpropane triacrylate, pentaerythritol triacrylate, pentaerythritol tetraacrylate, dipentaerythritol hexaacrylate, ditrimethylolpropane tetraacrylate, glycerin propoxytriacrylate, caprolactone modified trimethylolpropane triacrylate, pentaerythritol ethoxypentaacrylate, or caprolactum modified dipentaerythritol hexaacrylate.

One of the characteristic features of the present invention is to use a photo acid generator. Any photo acid generators known in the prior art are usable in the present invention.

As the photo acid generator, for example, a chemical amplification type photo resist or compound used for the photo cationic polymerization is used (Organic electronics material seminar “Organic material for imaging” from Bunshin publishing house (1993), refer to page 187-192). Examples preferable for the present invention will be listed below.

Firstly, aromatic onium compound B(C₆F₅)₄⁻, PF₆⁻, AsF₆⁻, SbF₆⁻, CF₃SO₃⁻ salt, such as diazonium, ammonium, iodonium, sulfonium, phosphonium, can be listed.

Specific examples of the onium compounds usable in the present invention will be shown below.

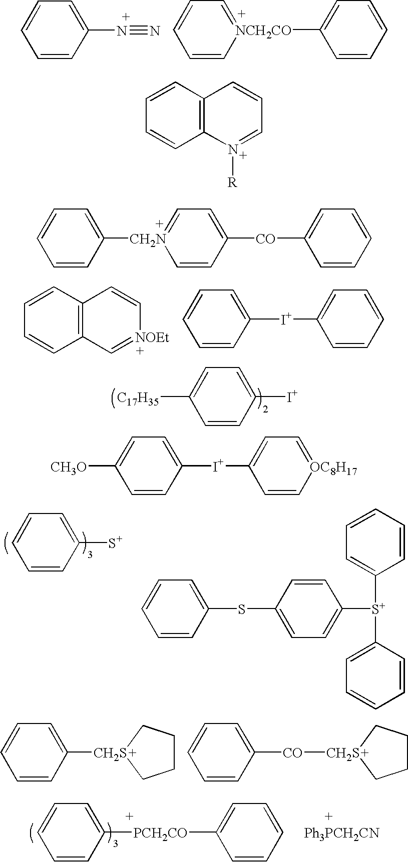

Secondly, sulfone compounds, which generate sulfonic acid, can be listed. Examples of specific compounds will be shown below.

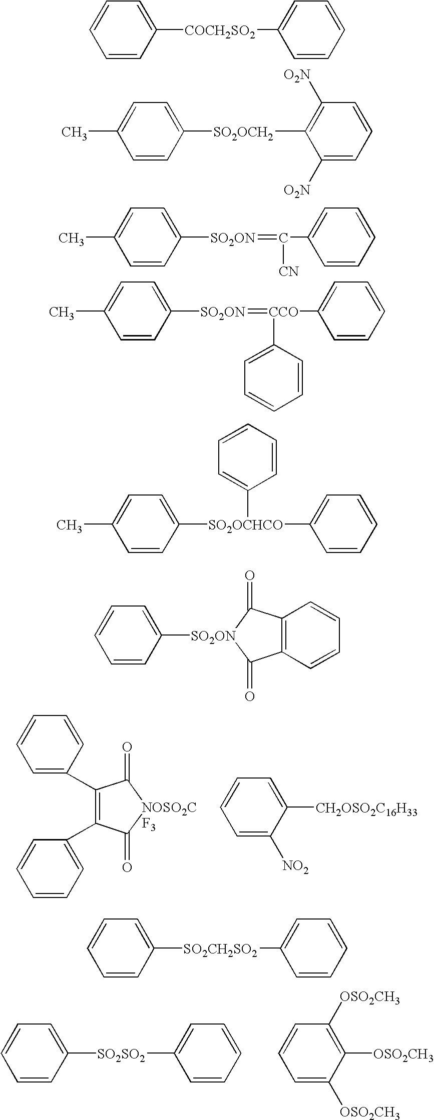

Thirdly, halide which generates hydrogen halide can also be used. Examples of specific compounds will be shown below.

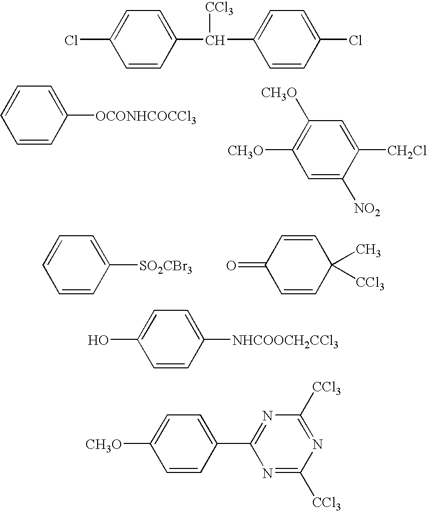

Fourthly, iron arene complex can be listed.

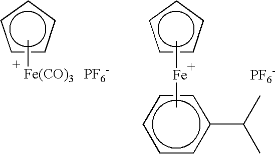

Further, employed as photolytically radical generating agents may be those known in the art, which include aryl alkyl ketones, oxime ketones, thiobenzoic acid S-phenyl, titanocene, aromatic ketones, thioxanthone, benzyl and quinone derivatives, as well as coumarins. In detail, reference may be made to “UV·EB Koka Gijutau no Oyo to Shijo (Application of UV·EB Curing Technology and Market)” (CMC Shuppan, compiled under the supervision of Inaho Tabata/edited by Radotekku Kenkyu Kai). Of these, acylphosphine oxides and acylphosphonates are particularly effective for internal curing of ink images of a thickness of 5-12 μm per color employed in the ink-jet system, since they result in high photographic speed and light absorption decreases due to the photo-cleavage of initiators. Specifically preferred of the above are bis(2,4,6-trimethylbenzoyl)-phenylphosphine oxides and bis(2,6-dimethoxybenzoyl)-2,4,4-trimethyl-pentylphosphine oxides.

Further, when considering safety, appropriately employed are 1-hydroxy-cyclohexyl phenyl ketone, 2-methyl-1 [4-(methylthio)phenyl-2-morpholinopropane-1-one, bis(2,6-dimethoxybenzoyl)2,4,4-trimethyl-pentylphosphine oxide, and 2-hydoxy-2-methyl-1-phenyl-propane-1-one (DAROCURE (trade name) 1174). The added amount is preferably 1-6 percent by weight with respect to the entire ink composition, but is more preferably 2-5 percent by weight.

The ink of the present invention preferably has a viscosity of 7 to 50 mPa·s at 25° C. to improve ejection stability regardless of the hardening conditions of temperature and moistures and to obtain a good hardening property.

As the recording material which can be used in the present invention, other than an ordinary non-coat sheet and coat sheet, each kind of non-absorptive plastic used for so-called soft package and its film can be used, and as each kind of plastic film, for example, PET film, OPS film, OPP film, ONy film, PVC film, PE film, or TAC film can be listed. As the other plastic, polycarbonate, acrylic resin, ABS, polyacetal, PVA, or rubber can be used. Further, it can also be applied to metal or glass.

In these recording materials, particularly when the image is formed onto the PET film, OPS film, OPP film, ONy film, PVC film, which are shrinkable by the heat, the structure of the present invention is effective. In these base materials, not only the curl and deformation of the film are easily generated by the heat generation at the time of curing shrinkage and curing reaction of the ink, but the ink film also hardly follows the shrinkage of the base material.

The surface energy of each kind of plastic film is largely different, and conventionally, it is a problem that the dot diameter after the ink impact is changed depending on the recording material. In the structure of the present invention, the good high minute image can be formed on the recording material of the wide range in which the surface energy is 3.5-6.0×10⁻² Nm⁻¹, including OPP film, OPS film, whose surface energy is low, and PET whose surface energy is comparatively large.

In the present invention, it is advantageous to use a long sized (web) recording material by considering the cost of the recording material such as the package cost and the production cost; the production efficiency of the print; and applicability to a various kinds of print size.

The image forming method of the present invention will be described below.

In the image forming method of the present invention, it is preferable to produce an image on an image forming material with an ink-jet recording method, then irradiate the formed image with an actinic ray such as a UV ray to cure the image.

(Thickness of Ink Layer Formed After Ink is Ejected Onto Recording Material)

In the present invention, the thickness of an ink layer, after ink has been ejected onto recording material and cured by actinic ray irradiation, is preferably from 2 to 25 μm. In actinic ray curable ink-jet recording in the field of screen printing, the thickness of the ink is at present over 25 μm. Ink ejection of an excessive layer thickness is not preferred in the field of flexible package printing where a thin plastic film is used as a recording material, because problems are caused in that stiffness and texture may change by such printing, in addition to the problems of the aforementioned curl and wrinkles of recording material.

Herein, the thickness of an ink layer refers to the maximum thickness of the ink layer deposited on the recording material. This is common to a single color ink layer, and an overlapped layer of two different color (secondary color) inks, three different color inks or four different color inks (including white ink as a base ink), which are formed on recording material according to an ink jet recording process.

(Ejecting Conditions of Ink)

In the image recording method of the present invention,

It is preferable that an ink-jet recording head as well as ink is maintained at 35-100° C., while the resulting ink is ejected onto recording materials to obtain high ejection stability

An actinic ray curable ink exhibits a broad viscosity range depending largely on the change of temperature, and viscosity variation directly affects the size and ejection rate of ink droplets, resulting in degradation of image quality. Consequently, it is necessary to maintain a constant temperature. The controlled range of ink temperature is preferably the predetermined temperature ±5° C., is more preferably the predetermined temperature ±2° C., but is further more preferably the predetermined temperature ±1° C.

The droplet volume of the ink ejected from each ink nozzle is preferably 2 to 15 pl.

The droplet volume of the ink is preferably in the range described above to form high resolution images, however, it is not an easy matter to stably eject droplets in this volume range. In the present invention, even when a small droplet volume such as 2 to 15 pl is ejected, ejection stability is maintained, resulting in high resolution images.

(Actinic Ray Irradiation Condition After Ink has Been Ejected Onto Recording Material)

In the image recording method of the present invention, it is preferable that actinic rays are irradiated within 0.001 to 2.0 seconds after ink has been deposited on the recording material, and it is more preferable that actinic rays are irradiated within 0.001 to 1.0 second after ink has been deposited on recording material. Irradiation of actinic rays as early as possible after ejecting the ink is specifically important in order to form high resolution images.

An actinic ray irradiation method has been basically disclosed in JP-A No. 60-132767, in which light sources are provided at the both sides of a head unit where a head and a light are scanned in a shuttle system. Irradiation is performed in a certain time interval after ink has been deposited on the recording material. Further, curing is completed by another light source which is not driven. In U.S. Pat. No. 6,145,979, the following light irradiation methods have been disclosed: (i) a method utilizing optical fibers; and (ii) a method in which collimated light is reflected by a mirror provided on the side surface of a head unit, and UV light (ultraviolet light) is irradiated on the recording portion. In the image forming method of the present invention, any of these irradiation methods may be utilized.

Further, the following method is also preferable: irradiation of actinic rays is divided into two steps, (i) first actinic ray irradiation is 0.001 to 2.0 seconds after ink has been deposited on recording material by the above-described method; and (ii) second actinic ray irradiation is carried out after all the printing has been completed. Shrinkage of recording materials, occurring while the ink is being cured can be reduced by dividing actinic ray irradiation into those two steps.

In the past, in a UV curable ink-jet method, usually a high power light source exceeding 1 kW-hr has been used in order to minimize spreading of dots and bleeding-out after the ink deposition on recording material. However, specifically in printing on shrink labels, the shrinkage of the recording material due to the UV irradiation has been too much for practical use.

In the present invention, even when a light source with a power less than 1 kW-hr is used, images with high resolution can be formed, and shrinkage of a recording material is in the permissible range. Examples of the light sources having a power of less than 1 kW·hr include a fluorescent lamp, a cold cathode tube and a LED, however, the present invention is not limited thereto.

The ink-jet recording apparatus (hereafter, it is also referred to as a recording apparatus) of the present invention will be described.

The recording apparatus of the present invention will be described by reference with figures. The recording apparatus in the figures are exemplary embodiments and the recording apparatus of the present invention is not limited by them.

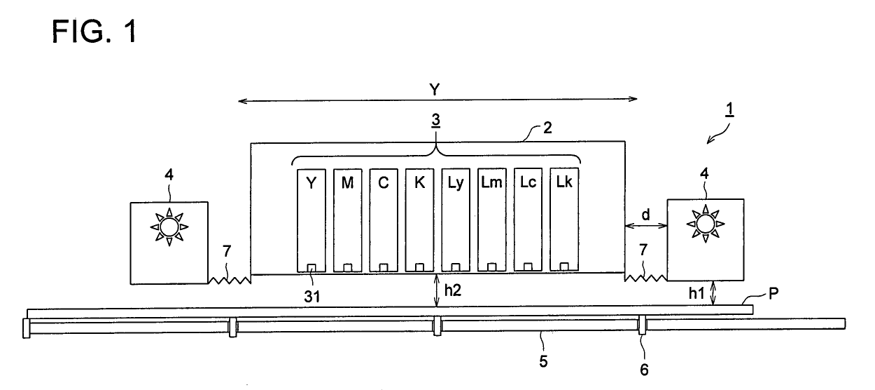

FIG. 1 shows a front view of the main section of the ink-jet recording apparatus of the present invention. Recording apparatus 1 is equipped with head carriage 2, recording head 3, irradiation member 4 and platen 5. In recording apparatus 1, platen 5 is provided under recording material P. Platen 5 functions also as a UV ray absorbing means, and absorbs excess UV rays having passed through recording material P. As a result, high resolution images are reproduced quite stably.

Recording material P is guided by guide member 6 to be moved to the back side from the front side in FIG. 1 by means of a transport member (not illustrated). Scanning of recording heads 3 mounted in the head carriage 2 is achieved by reciprocating head carriage 2 in the Y direction in FIG. 1 by means of a head scanning member (not illustrated).

Head carriage 2 is provided over recording material P, and stores a plurality of recording heads 3 described below with the ink ejection orifices oriented downward. Head carriage 2 is provided in the main body of recording apparatus 1 so as to reciprocate in the Y direction, as shown in FIG. 1, driven by a head scanning member.

Herein, FIG. 1 illustrates that head carriage 2 carries ten recording heads 3, however, in the present invention, the number of recording heads 3 mounted in head carriage 2 is determined considering the number of inks.

Recording heads 3 eject an actinic ray curable ink (for example, a UV curable ink) supplied by an ink supplying member (not illustrated) from the ink ejection orifices onto recording material P by action of plural ejecting members (not illustrated) equipped in the recording apparatus. The UV curable ink ejected from recording heads 3 is a composition containing a colorant, a polymerizable polymer and an initiator, and has a property to be cured via a cross-linking and polymerizing reaction initiated by irradiation of UV rays where the initiator works as a catalyst.

Recording heads 3 ejects ink as ink droplets onto a pre-determined region (the region designated to receive the ink) of recording material P while the head is scanned from one edge to the other of the recording sheet in the Y direction in FIG. 1 by means of the head scanning member, whereby the ink is deposited on the designated region of the recording sheet.

The above scan is made several times as required to eject ink onto the region designated to receive the ink. After that, recording material P is transported from the front side to the back side of the page in FIG. 1 by a transport member and the scan of the recording heads 3 is again made, driven by the head scan member, whereby ink is ejected from the recording heads onto an adjacent region designated to receive the ink.

The above operation is repeatedly carried out, whereby the ink is ejected from recording heads 3 employing the head scan member and the transport member to form an image made of aggregates of ink droplets on recording material P.

Irradiation member 4 is equipped with a UV lamp which emits ultraviolet rays of a specific wavelength range at a stable exposure energy and a filter which transmits ultraviolet rays of a specific wavelength. Herein, examples of the UV lamp include a mercury lamp, a metal halide lamp, an excimer laser, a UV laser, a cold cathode tube, a hot cathode tube, a black light, and an LED (light emitting diode). Of these, a metal halide lamp giving a band-shaped light, a cold cathode tube, a mercury lamp and a black light are preferable. Specifically a cold cathode tube and a black light, which emit 254 nm ultraviolet rays are preferable, which can prevent bleeding-out, efficiently control a dot diameter, and reduce wrinkles on curing. Utilizing a black light as a radiation source of irradiation member 4 reduces the manufacturing cost for ink curing.

Irradiation member 4 has the possible largest size which can be installed in recording apparatus 1 (an ink jet printer) or the size which is larger than the region designated to receive the ink by one scan of recording heads 3, driven by the head scanning member.

Irradiation member 4 is equipped nearly in parallel with recording material P by fixing at the both sides of head carriage 2.

In order to adjust luminance at the ink ejection outlets, the entire recording heads 3 is light-shielded, however, in addition, it is preferable to make distance h2 between the ink ejection outlet 31 of recording heads 3 and recording material P greater than distance h1 between irradiation means 4 and recording material P (h1<h2) or to increase distance d between recording heads 3 and irradiation means 4 long (to make d large). Further, it is more preferable to provide bellows structure 7 between recording heads 3 and irradiation member 4.

Herein, the wavelength of ultraviolet rays, which are irradiated through irradiation member 4, is suitably changed by exchange of a UV lamp or a filter, which is mounted in irradiation member 4.

The ink-jet ink of the present invention has excellent ejection stability, and is specifically suitable for use in a line head type ink-jet recording apparatus.

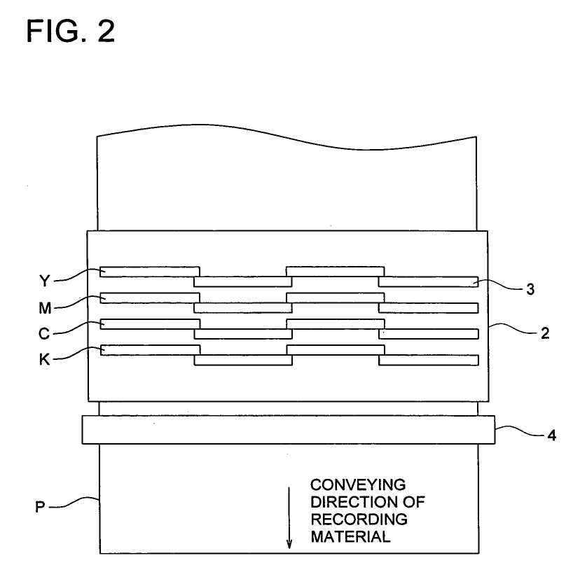

FIG. 2 shows a top view of the main section of the ink-jet recording apparatus explaining another embodiment of the present invention.

The ink-jet recording apparatus illustrated in FIG. 2 is called as a line head type ink-jet recording apparatus. Recording heads 3 are provided in head carriage 2, which covers the entire width of recording material P. The recording heads 3 each stores a different color ink.

Irradiation means 4 is provided just downstream of head carriage 2 to cover the entire width of recording material P and the entire printing surface. The same ultraviolet lamp as shown in FIG. 1 may be used in the irradiation means 4 in FIG. 2.

In the line head type recording apparatus, head carriage 2 and irradiation means 4 are fixed, and only recording material P is transported in the direction as shown in FIG. 2. Ink is ejected onto the recording sheet, which is subsequently transported and then exposed via the irradiation means to form a cured image on the recording sheet.

### EXAMPLES

The present invention will now be explained using examples, however, the present invention is not limited thereto.

<Determination of the Amine Value of Dispersing Agents>

A dispersing agent was dissolved in methyl isobutyl ketone, and potentiometric titration was performed employing a 0.01 mol/L perchloric acid methyl isobutyl ketone solution. The amine value was determined by converting the resulting value to KOH mg/g. The potentiometric titration was performed employing automatic titrator COM-1500, produced by Hiranuma Industries Co., Ltd.

<Determination of the Acid Value of Dispersing Agents>

A dispersing agent was dissolved in methyl isobutyl ketone, and potentiometric titration was performed employing a 0.01 mol/L potassium methoxide-methyl isobutyl ketone/methanol (4:1) solution. The acid value was determined by converting the resulting value to KOH mg/g. The potentiometric titration was performed employing automatic titrator COM-1500, produced by Hiranuma Sangyo Co., Ltd.

(Determination of the Amine Value of Pigments>

Added to a pigment was a 0.01 mol/L perchloric acid methyl butyl ketone solution, and the resulting mixture was subjected to ultrasonic dispersion. Thereafter, the supernatant was subjected to centrifugal separation and to potentiometric titration, employing a 0.1 mol/L potassium methoxide-methyl isobutyl ketone/methanol (4:1) solution. The decreased amount of the perchloric acid due to the pigment was converted to KOH mg/g. The resulting value was designated as the amine value. The potentiometric titration was performed employing automatic titrator COM-1500 produced by Hiranuma Sangyo Co., Ltd.

<Determination of the Acid Value of Pigments>

Added to a pigment was a 0.01 mol/L terabutyl ammonium hydroxide-methyl butyl ketone solution and the resulting mixture was subjected to ultrasonic dispersion. Thereafter, the supernatant was subjected to centrifugal separation and to potentiometric titration, employing a 0.01 mol/L perchloric acid methyl isobutyl ketone solution. The decreased amount of 0.01 mol/L tetrabutyl ammonium hydroxide due to the pigment was converted to KOH mg/g. The resulting value was designated as the acid value. The potentiometric titration was performed employing automatic titrator COM-1500 produced by Hiranuma Sangyo Co., Ltd.

<Amine Values and Acid Values of Employed Pigments>

Pigment 1: Pigment Black 7 (# 52, produced by Mitsubishi Chemical Corporation; amine value: 3 mg/g, acid value: 6 mg/g)

Pigment 1′: Pigment Black 7 (MA7, produced by Mitsubishi Chemical Corporation; amine value: 3 mg/g, acid value: 15.2 mg/g)

Pigment 2: Pigment Blue 15:4 (Cyanine Blue 4044, produced by Sanyo Color Works, Ltd; amine value: 8.0 mg/g, acid value: 0.0 mg/g)

Pigment 2′: Pigment Blue 15: 4 (produced by Dainichiseika Color & Chemicals Mfg. CO. Ltd.; amine value: 7.8 mg/g, acid value: 1.9 mg/g)

Pigment 3: Pigment Red 122 (CFR321, produced by Dainichiseika Color & Chemicals Mfg. CO. Ltd.; amine value: 6.1 mg/g, acid value: 4.1 mg/g)

Pigment 3′: Pigment Violet 19 (CFR338-3, produced by Dainichiseika Color & Chemicals Mfg. CO. Ltd.; amine value: 5.8 mg/g, acid value: 4.0 mg/g)

Pigment 4: Pigment Yellow 138 (CFY340, produced by Dainichiseika Color & Chemicals Mfg. CO. Ltd.; amine value: 5.8 mg/g, acid value: 2.6 mg/g)

Pigment 5: Pigment Yellow 151 (E4GN-GT, produced by LANXESS Corporation; amine value: 9.1 mg/g, acid value: 6.4 mg/g)

Pigment 6: Pigment Yellow 180 (CFY313-2, produced by Dainichiseika Color & Chemicals Mfg. CO. Ltd.; amine value: 4.9 mg/g, acid value: 3.0 mg/g)

Pigment 6′: Pigment Yellow 138 (Novoperm Yellow HG, produced by Clariant Corporation; amine value 40. mg/g, acid value: 4.0 mg/g)

<Preparation of Dispersion A>

A pigment was dispersed employing the following composition. The compounds below were charged into a stainless steel beaker, which was heated on a hot plate to 65° C., and were dissolved while stirring for one hour.

PB822 (dispersing agent, produced by Ajinomoto Fine Techno Co.;

| | |
|---|---|
| PB822 (dispersing agent, produced by | 8 parts |
| Ajinomoto Fine Techno Co.; | |
| acid value of 18.5 mg/g and an amine | |
| value of 15.9 mg/g) | |
| Tetraethylene glycol diacrylate | 72 parts |
| (bi-functional) | |

After cooling the above composition to room temperature, 20 parts of each of above Pigments 1, 2, 3, and 4 were added. Subsequently, the resulting mixture was charged into a glass vessel together with 200 g of diameter 0.3 mm zirconia beads, tightly sealed, and dispersed for 4 hours employing a paint shaker. Thereafter, zirconia beads were removed, and the resulting dispersion was designated as Dispersion A.

<Preparation of Dispersion B>

A pigment was dispersed employing the following composition. The compounds below were charged into a stainless steel beaker which was heated on a hot plate to 65° C. and were dissolved while stirring for one hour.

PB821 (dispersing agent, produced by Ajinomoto Fine Techno Co.;

| | |
|---|---|
| PB821 (dispersing agent, produced by | 9 parts |
| Ajinomoto Fine Techno Co.; | |
| acid value of 30.4 mg/b and an amine | |
| value of 10.2 mg/g) | |
| OXT211 (oxetane compound, produced by Toa | 72 parts |
| Gosei Co., Ltd.) | |

After cooling the above composition to room temperature, 20 parts of each of above Pigments 1, 2, 3′, and 4 were added. Subsequently, the resulting mixture was charged into a glass vessel together with 200 g of diameter 0.3 mm zirconia beads, tightly sealed, and dispersed for 4 hours employing a paint shaker. Thereafter, zirconia beads were removed, and the resulting dispersion was designated as Dispersion B.

<Preposition of Dispersion C>

A pigment was dispersed employing the following composition. The compounds below were charged into a stainless steel beaker which was heated on a hot plate to 65° C. and were dissolved while stirring for one hour.

ED-251 (dispersing agent, produced by Kusumoto Chemicals, Ltd.;

| | |
|---|---|
| ED-251 (dispersing agent, produced by | 10 parts |
| Kusumoto Chemicals, Ltd.; | |
| acid value of 13.4 mg/g and an amine | |
| value of 15.9 mg/g) | |
| Tetraethylene glycol diacrylate | 70 parts |
| (bi-functional) | |

After cooling the above composition to room temperature, 20 parts of each of above Pigments 1, 2, 3, and 4 were added. Subsequently, the resulting mixture was charged into a glass vessel together with 200 g of diameter 0.3 mm zirconia beads, tightly sealed, and dispersed for 4 hours employing a paint shaker. Thereafter, zirconia beads were removed, and the resulting dispersion was designated as Dispersion C.

<Preparation of Dispersion D>

A pigment was dispersed employing the following composition. The compounds below were charged into a stainless steel beaker which was heated on a hot plate to 65° C. and were dissolved while stirring for one hour.

PB822 (dispersing agent, produced by Ajinomoto Fine Techno Co.;

| | |
|---|---|
| PB822 (dispersing agent, produced by | 8 parts |
| Ajinomoto Fine Techno Co.; | |
| an acid value of 18.5 mg/b and an amine | |
| value of 15.9 mg/g) | |
| OXT221 (oxetane compound, produced by Toa | 72 parts |
| Gosei Co., Ltd.) | |

After cooling the above composition to room temperature, 20 parts of each of above Pigments 1, 2, 3′, and 4 were added. Subsequently, the resulting mixture was charged into a glass vessel together with 200 g of diameter 0.3 mm zirconia beads, tightly sealed, and dispersed for 4 hours employing a paint shaker. Thereafter, zirconia beads were removed, and the resulting dispersion was designated as Dispersion D.

<Preparation of Dispersion E> (Dispersing Agent is Basic)

A pigment was dispersed employing the following composition. The compounds below, charged into a stainless steel beaker, were stirred.

DISPERBYK161 (dispersing agent, produced by Big Chemie Co.;

| | |
|---|---|
| DISPERBYK161 (dispersing agent, produced by | 8 parts |
| Big Chemie Co.; | |
| acid value of 4.4 mg/g and an amine value | |
| of 10.9 mg/g) | |
| OXT221 | 72 parts |

Above Pigments 1, 2, 3, and 4 in an amount of 20 parts were added. Subsequently, the resulting mixture was charged into a glass vessel together with 200 g of diameter 0.3 mm zirconia beads, tightly sealed, and dispersed for 4 hours employing a paint shaker. Thereafter, zirconia beads were removed, and the resulting dispersion was designated as Dispersion E.

<Preparation of Dispersion F> (Dispersing Agents are Basic)

A pigment was dispersed employing the following composition. The compounds below were charged into a stainless steel beaker which was heated on a hot plate to 65° C. and were dissolved while stirring for one hour.

SOLSPERSE 32000 (dispersing agent produced by Avicia Co., Ltd.;

| | |
|---|---|
| SOLSPERSE 32000 (dispersing agent produced | 8 parts |
| by Avicia Co., Ltd.; | |
| an acid value of 24.8 mg/g and an amine | |
| value of 27.1 mg/g) | |
| OXT221 | 72 parts |

Above Pigments 1, 2, 3′, and 4 in an amount of 20 parts were added. Subsequently, the resulting mixture was charged into a glass vessel together with 200 g of diameter 0.3 mm zirconia beads, tightly sealed, and dispersed for 4 hours employing a paint shaker. Thereafter, zirconia beads were removed, and the resulting dispersion was designated as Dispersion F.

<Preparation of Dispersion G> (Bk, Y; High Acid Value)

A pigment was dispersed employing the following composition. The compounds below were charged into a stainless steel beaker which was heated on a hot plate to 65° C. and were dissolved while stirring for one hour.

PB822 (dispersing agent produced by Ajinomoto Fine Techno Co., Ltd.;

| | |
|---|---|
| PB822 (dispersing agent produced | 8 parts |
| by Ajinomoto Fine Techno Co., Ltd.; | |
| an acid value of 18.5 mg/g and an amine | |
| value of 15.9 mg/g) | |
| OXT221 | 72 parts |

Above Pigments 1′, 2′, 3, and 6′ in an amount of 20 parts were added. Subsequently, the resulting mixture was charged into a glass vessel together with 200 g of diameter 0.3 mm zirconia beads, tightly sealed, and dispersed for 4 hours employing a paint shaker. Thereafter, zirconia beads were removed, and the resulting dispersion was designated as Dispersion G.

<Preparation of Dispersion H>

A pigment was dispersed employing the following composition. The compounds below were charged into a stainless steel beaker which was heated on a hot plate to 65° C. and were dissolved while stirring for one hour.

HINOACT (dispersing agent produced by Kawaken Fine Chamical Co., Ltd.;

| | |
|---|---|
| HINOACT (dispersing agent produced | 15 parts |
| by Kawaken Fine Chamical Co., Ltd.; | |
| an acid value of 26.2 mg/g and an amine | |
| value of 17.8 mg/g) | |
| OXT221 | 65 parts |

Above Pigments 1, 2, 3, and 5 in an amount of 20 parts were added. Subsequently, the resulting mixture was charged into a glass vessel together with 200 g of diameter 0.3 mm zirconia beads, tightly sealed, and dispersed for 8 hours employing a paint shaker. Thereafter, zirconia beads were removed, and the resulting dispersion was designated as Dispersion H.

<Preparation of Dispersion I>

A pigment was dispersed employing the following composition. The compounds below were charged into a stainless steel beaker which was heated on a hot plate to 65° C. and were dissolved while stirring for one hour.

PB822 (dispersing agent produced by Ajinomoto Fine Techno Co., Ltd.;

| | |
|---|---|
| PB822 (dispersing agent produced | 10 parts |
| by Ajinomoto Fine Techno Co., Ltd.; | |
| an acid value of 18.5 mg/g and an amine | |
| value of 15.9 mg/g) | |
| DVE-3 (vinyl ether compound produced by | 70 parts |
| ISP Japan Co. Ltd.) | |

Above Pigments 1, 2, 3, and 5 in an amount of 20 parts were added. Subsequently, the resulting mixture was charged into a glass vessel together with 200 g of diameter 0.3 mm zirconia beads, tightly sealed, and dispersed for 8 hours employing a paint shaker. Thereafter, zirconia beads were removed, and the resulting dispersion was designated as Dispersion I.

<Preparation of Actinic ray Curable Ink-jet Ink (Hereinafter Also Referred Simply to as Ink)>

Inks were prepared which were composed of the ink compositions described in Tables 1 and 2. Each of the resulting inks was subjected to centrifugal separation at 3,000 rpm for one hour and subsequently filtered employing 3 μm TEFLON (registered trade name) membrane filter produced by ADVATEC Co.). In regard to ink compositions 2, 3, 5, and 6, inks were also prepared as a comparative example in such a manner than they were not subjected to centrifugal separation and filtered employing a 10 μm CMF membrane filter produced by ADVATEC Co.

TABLE 1-1

| | K | C | M | Y | Lk | Lc | Lm | Ly |
|---|---|---|---|---|---|---|---|---|
| Pigment | 1 | 2 | 3 | 4 | 1 | 2 | 3 | 4 |

Ink Compositing 1 (Comparative Example)
Viscosity of Each Color Ink: 18-21 mPa · s (25° C.)

| | | | | | | | | | |
|---|---|---|---|---|---|---|---|---|---|
| Dispersion E | | 14.0 | 14.0 | 15.0 | 15.0 | 3.5 | 3.5 | 3.8 | 3.8 |
| Photopolymerizable | CELOXIDE 3000 (Diacel | 33.0 | 33.0 | 32.0 | 32.0 | 43.5 | 43.5 | 43.3 | 43.3 |
| Compound (alicyclic | Chemical) | | | | | | | | |
| epoxy compound) | | | | | | | | | |
| Photopolymerizable | OXT-221 (Toa Gosei) | 30.0 | 30.0 | 30.0 | 30.0 | 30.0 | 30.0 | 30.0 | 30.0 |
| Compound (oxetane | | | | | | | | | |
| compound) | | | | | | | | | |
| Photopolymerizable | OXT-101 (Toa Gosei) | 20.0 | 20.0 | 20.0 | 20.0 | 20.0 | 20.0 | 20.0 | 20.0 |
| Compound | | | | | | | | | |
| (oxetane compound) | | | | | | | | | |
| Photolytically Acid | DTS-102 (Midori Kagaku) | 3.0 | 3.0 | 3.0 | 3.0 | 3.0 | 3.0 | 3.0 | 3.0 |
| Generating Agen | | | | | | | | | |

Ink Composition 2 (Present Invention)
Viscosity of Each Color Ink: 30-32 mPa · s (25° C.)

| | | | | | | | | | |
|---|---|---|---|---|---|---|---|---|---|
| Dispersion A | | 14.0 | 14.0 | 15.0 | 15.0 | 3.5 | 3.5 | 3.8 | 3.8 |
| Photopolymerizable | lauryl acrylate | 24.9 | 24.9 | 23.9 | 23.9 | 35.4 | 35.4 | 35.2 | 35.2 |
| Compound | (uni-functional) | | | | | | | | |
| Photopolymerizable | tetraethylene glycol | 30.0 | 30.0 | 30.0 | 30.0 | 30.0 | 30.0 | 30.0 | 30.0 |
| Compound | diacrylate (bi-functional) | | | | | | | | |
| Photopolymerizable | caprolactum-modified | 25.0 | 25.0 | 25.0 | 25.0 | 25.0 | 25.0 | 25.0 | 25.0 |
| Compound | pentaerythritol | | | | | | | | |
| | hexaacrylate | | | | | | | | |
| | (hexa-functional) | | | | | | | | |
| Modified Silicone | SDX-1843 (Asahi Denka Kogyo) | 0.10 | 0.10 | 0.10 | 0.10 | 0.10 | 0.10 | 0.10 | 0.10 |
| Oil | | | | | | | | | |
| Photo-radical | IRUGACURE 184 (produced | 3.0 | 3.0 | 3.0 | 3.0 | 3.0 | 3.0 | 3.0 | 3.0 |
| Initiator | by Ciba Specialty Chemicals Co.) | | | | | | | | |
| Photo-radical | IRUGACURE 907 (produced | 3.0 | 3.0 | 3.0 | 3.0 | 3.0 | 3.0 | 3.0 | 3.0 |
| Initiator | by Ciba Specialty Chemicals Co.) | | | | | | | | |

TABLE 2
Ink Composition 4 (Comparative Example)
Viscosity of Each Color Ink: 28-32 mPa · s (25° C.)

| | | K | C | M | Y |
|---|---|---|---|---|---|
| Pigment | | 1 | 2 | 3′ | 4 |
| Dispersion F | | 14.0 | 14.0 | 15.0 | 15.0 |
| Photopolymerizable | UVR-6110 (Dow Chemical) | 25.9 | 25.9 | 24.9 | 24.9 |
| Compound (cyclic | | | | | |
| epoxy compound) | | | | | |
| Photopolymerizable | OXT-221 (Toa Gosei) | 36.0 | 36.0 | 36.0 | 36.0 |
| Compound (oxetane | | | | | |
| compound) | | | | | |
| Photopolymerizable | OXT-211 (Toa Gosei) | 20.0 | 20.0 | 20.0 | 20.0 |
| Compound (oxetane | | | | | |
| compound) | | | | | |
| Basic Compound | tributylamine | 0.1 | 0.1 | 0.1 | 0.1 |
| Photolytically Acid | IRUGACURE 250 Ciba Specialty | 4.0 | 4.0 | 4.0 | 4.0 |
| Generating Agent | Chemicals) | | | | |

Ink Composition 5 (Present Invention)
Viscosity of Each Color Ink: 26-30 mPa · s (25° C.)

| | | K | C | M | Y |
|---|---|---|---|---|---|
| Pigment | | 1 | 2 | 3 | 4 |
| Dispersion C | | 14.0 | 14.0 | 15.0 | 15.0 |
| Photopolymerizable | NK ESTER A-400 (Shin-Nakamura | 25 | 20 | 25 | 20 |
| Compound | Chemical) | | | | |
| Water | pure water | 38.0 | 43.0 | 37.0 | 42.0 |
| Water-soluble Organic | diethylene glycol (reagent) | 5 | 5 | 5 | 5 |
| solvent | | | | | |
| Water-soluble Organic | isopropyl alcohol (reagent) | 12 | 12 | 12 | 12 |
| Solvent | | | | | |
| Photo-radical | IRUGACURE 2959 (Ciba Specialty | 3 | 3 | 3 | 3 |
| Initiator | Chemicals) | | | | |
| Photo-radical | IRUGACURE 651 (Ciba Specialty | 3 | 3 | 3 | 3 |
| Initiator | Chemicals) | | | | |

Ink Compositing 6 (Present Invention)
Viscosity of Each Color Ink: 26-29 mPa · s (25° C.)

| | | K | C | M | Y |
|---|---|---|---|---|---|
| Pigment | | 1 | 2 | 3′ | 4 |
| Dispersion D | | 14.0 | 14.0 | 15.0 | 15.0 |
| Photopolymerizable | OXT-221 (Toa Gosei) | 30.0 | 30.0 | 30.0 | 30.0 |
| Compound (oxetane | | | | | |
| compound) | | | | | |
| Photopolymerizable | CELOXIDE 2021P (Daicel | 10.0 | 10.0 | 10.0 | 10.0 |
| Compound (alicyclic | Chemical) | | | | |
| epoxy compound) | | | | | |
| Photopolymerizable | OXT-212 (Toa Gosei) | 10.0 | 10.0 | 10.0 | 10.0 |
| Compound (oxetane | | | | | |
| compound) | | | | | |
| Photopolymerizable | E-4030 (Shin-Nippon Rika) | 10.8 | 10.8 | 9.8 | 9.8 |
| Compound (epooxydized | | | | | |
| fatty acid butyl) | | | | | |
| Photopolymerizable | Compound EP-2 | 15.0 | 15.0 | 15.0 | 15.0 |
| Compound (alicyclic | | | | | |
| epoxy compound) | | | | | |
| Basic Compound | Triisopropanolamine | 0.1 | 0.1 | 0.1 | 0.1 |
| Modified Silicone Oil | XF42-334 (G.E. Toshiba | 0.10 | 0.10 | 0.10 | 0.10 |
| | Silicone) | | | | |
| Anisole | HICHEMIC MB (Toho Kagaku) | 5.00 | 5.00 | 5.00 | 5.00 |
| (compatibilizer) | | | | | |
| Photolytically Acid | SP152 (Asahi Denka Kogyo) | 5.0 | 5.0 | 5.0 | 5.0 |
| Generating Agent | | | | | |

Ink Composition 7 (Inventive Example)
Viscosity of Each Color Ink: 25-28 mPa · s (25° C.)

| | | K | C | M | Y |
|---|---|---|---|---|---|
| Pigment | | 1′ | 2′ | 3 | 6′ |
| Dispersion G | | 14.0 | 14.0 | 15.0 | 15.0 |
| Photopolymerizable | Compound EP-1 | 26.7 | 26.7 | 25.7 | 25.7 |
| Compound (cyclic | | | | | |
| epoxy compound) | | | | | |
| Photopolymerizable | OXT-221 (Toa Gosei) | 45.0 | 45.0 | 45.0 | 45.0 |
| Compound (oxetane | | | | | |
| compound) | | | | | |
| Photopolymerizable | OXT-213 (Toa Gosei) | 10.0 | 10.0 | 10.0 | 10.0 |
| Compound (oxetane | | | | | |
| compound) | | | | | |
| Basic Compound | tributylamine | 0.3 | 0.3 | 0.3 | 0.3 |
| Photolytically Acid | IRUGACURE 250 Ciba Specialty | 4.0 | 4.0 | 4.0 | 4.0 |
| Generating Agent | Chemicals) | | | | |
| Sensitizer | Diethylthioxanthone | 0.8 | 0.8 | 0.8 | 0.8 |

Ink Composition 8 (Inventive Example)
Viscosity of Each Color Ink: 32-36 mPa · s (25° C.)

| | | K | C | M | Y |
|---|---|---|---|---|---|
| Pigment | | 1 | 2′ | 3 | 5 |
| Dispersion H | | 20.0 | 20.0 | 27.5 | 30.0 |
| Photopolymerizable | UVR-6110 (Dow Chemical) | 28.9 | 28.9 | 27.4 | 27.9 |
| Compound (cyclic | | | | | |
| epoxy compound) | | | | | |
| Photopolymerizable | OXT-221 (Toa Gosei) | 36.0 | 36.0 | 30.0 | 27.0 |
| Compound (oxetane | | | | | |
| compound) | | | | | |
| Photopolymerizable | OXT-211 (Toa Gosei) | 10.0 | 10.0 | 10.0 | 10.0 |
| Compound (oxetane | | | | | |
| compound) | | | | | |
| Basic Compound | N-ethyldiethanolamine | 0.1 | 0.1 | 0.1 | 0.1 |
| Photolytically Acid | UVI6976 (Dow Chemical) | 5.0 | 5.0 | 5.0 | 5.0 |
| Generating Agent | | | | | |
| Anthrathene | DBA (Kawasaki Kasei) | 1.0 | 1.0 | 1.0 | 1.0 |
| derivative | | | | | |

Ink Composition 9 (Comparative Example)
Viscosity of Each Color Ink: 18-22 mPa · s (25° C.)

| | | K | C | M | Y |
|---|---|---|---|---|---|
| Pigment | | 1 | 2 | 3 | 5 |
| Dispersion I | | 20.0 | 20.0 | 27.5 | 30.0 |
| Photopolymerizable | CHVE (ISP Japan) | 19.9 | 19.9 | 18.9 | 18.9 |
| Compound (vinyl | | | | | |
| ether compound) | | | | | |
| Photopolymerizable | ODVE-3 (ISP Japan) | 40.0 | 40.0 | 40.0 | 40.0 |
| Compound (vinyl | | | | | |
| ether compound) | | | | | |
| Photopolymerizable | UVR-6110 (Dow Chemical) | 20.0 | 20.0 | 20.0 | 20.0 |
| Compound (cyclic | | | | | |
| epoxy compound) | | | | | |
| Basic Compound | Tripropanolamine | 0.1 | 0.1 | 0.1 | 0.1 |
| Photolytically Acid | UVI6992 (Dow Chemical) | 6.0 | 6.0 | 6.0 | 6.0 |
| Generating Agent | | | | | |

Compound EP-1 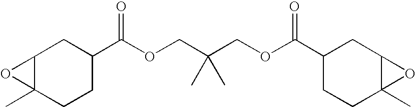
Compound EP-2

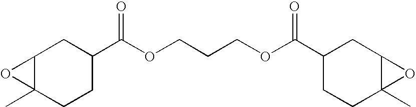

The inks in Tables are as follows.
K: dark black ink
C: dark cyan ink
M: dark magenta ink
Y: dark yellow ink
Lk: light black ink
Lc: light cyan ink
Lm: light magenta ink
Ly: light yellow ink
   <<Method for Forming Ink-Jet Images>>

Each of Ink Composition Sets 1-3, prepared as above, was loaded into an ink-jet recording apparatus, provided with piezo type ink-jet nozzles, which was constituted as shown in FIG. 1, and image recording described below was continuously performed on respective 600 mm wide by 500 m long recording materials each having the surface energy listed in Table 3. The ink feeding system containing an ink tank, a feeding pipe, a pre-chamber ink tank just prior to the head, piping with filters, and piezo heads, and the portion from the pre-chamber tank to the heads was insulated from heat, was heated to 50° C. The piezo head was driven so that 2-15 pl multi-size dots were ejected at a resolution of 720×720 dpi and each ink was continuously ejected. After deposition of the ink droplets, ultraviolet radiation was instantly (less than 0.5 second after deposition) irradiated employing each of the radiation sources listed in Table 7, which were arranged as lamp units on both sides of the carriage, whereby the ink was cured. The total ink layer thickness was determined after image recording, resulting in the range of 2.3-13 μm. Incidentally, dpi represents the number of dots per 2.54 cm. The formation of ink-jet images were carried out under the conditions of 27° C. and 80% RH.

Subsequently, by employing the ink-jet recording apparatus of the line head system described in FIG. 2, each of the images was formed in the same manner, while employing each of Ink Composition Sets 4-6, onto a recording material having a size of 600 mm wide by 500 m long shown in Table 3.

Further, a heating plate was provided on the platen section and the temperature of the heating plate was controlled so that the surface of each recording material reached 40° C. Sample Nos. 1-24 were thus prepared.

The average particle diameter, as described herein, refers to the volume average particle diameter determined by ZETASIZER NANO SERIES produced by Malvern Instruments Ltd. The number of coarse particles of a particle diameter of at least 1 μm was determined as follows. An ink was applied onto a substrate at a thickness of 3 μm, employing a bar coating method, and the number of particles of at least 1 μm diameter in the resulting coating in a definite area was counted employing an optical microscope (KEYENCE Digital Microscope VHX-100, Lenz VH-2100), and the counted number was converted to the value per μl of the ink.

TABLE 3

| | | | Average | | | | | | | |
|---|---|---|---|---|---|---|---|---|---|---|
| | | | Particle | | | Exposure | | | | |
| | | | Diameter | | | Conditions | | | | |
| | | | of Each | | | Exposure | | Exposure | | |
| Sample | | | Color | | Recording | Light | Exposure | Method | *2 | |
| No. | Ink | Filtration | (nm) | *1 | Material | Source | timing | (area) | *4 | Remarks |
| 1 | Ink | centrifugal | 110-232 | 3.0 × 10⁵ | PET | *5 | *7 | *8 | *10 | Com. |
| | Composition 1 | separation + TEFLON | | | | | | | | |
| | | 3 μm | | | | | | | | |
| 2-1 | Ink | centrifugal | 100-175 | 2.0 × 10⁵ | PET | *5 | *7 | *8 | *10 | Inv. |
| | Composition 2 | separation + TEFLON | | | | | | | | |
| | | 3 μm | | | | | | | | |
| 2-2 | Ink | centrifugal | 100-175 | 2.0 × 10⁵ | UPO FGS | *5 | *7 | *8 | *10 | Inv. |
| | Composition 2 | separation + TEFLON | | | | | | | | |
| | | 3 μm | | | | | | | | |
| 3-1 | Ink | CMF 10 μm | 108-186 | 7.0 × 10⁷ | PET | *5 | *7 | *8 | *10 | Com. |
| | Composition 2 | | | | | | | | | |
| 3-2 | Ink | CMF 10 μm | 108-186 | 7.0 × 10⁷ | UPO FGS | *5 | *7 | *8 | *10 | Com. |
| | Composition 2 | | | | | | | | | |
| 4 | Ink | centrifugal | 99-178 | 5.0 × 10⁴ | PET | *5 | *7 | *8 | *10 | Inv. |
| | Composition 3 | separation + TEFLON | | | | | | | | |
| | | 3 μm | | | | | | | | |
| 5 | Ink | CMF 10 μm | 104-183 | 2.0 × 10⁸ | PET | *5 | *7 | *8 | *10 | Com. |
| | Composition 3 | | | | | | | | | |
| 6 | Ink | centrifugal | 105-246 | 9.0 × 10⁵ | UPO FGS | *6 | *7 | *9 | *11 | Com. |
| | Composition 4 | separation + TEFLON | | | | | | | | |
| | | 3 μm | | | | | | | | |
| 7 | Ink | centrifugal | 107-231 | 4.0 × 10⁵ | fine- | *6 | *7 | *9 | *11 | Inv. |
| | Composition 5 | separation + TEFLON | | | quality | | | | | |
| | | 3 μm | | | paper | | | | | |
| 8 | Ink | CMF 10 μm | 110-245 | 8.0 × 10⁸ | fine- | *6 | *7 | *9 | *11 | Com. |
| | Composition 5 | | | | quality | | | | | |
| | | | | | paper | | | | | |
| 9 | Ink | centrifugal | 97-154 | 5.0 × 10⁴ | UPO FGS | *6 | *7 | *9 | *11 | Inv. |
| | Composition 6 | separation + TEFLON | | | | | | | | |
| | | 3 μm | | | | | | | | |
| 10 | Ink | CMF 10 μm | 104-163 | 2.0 × 10⁶ | UPO FGS | *6 | *7 | *9 | *11 | Com. |
| | Composition 6 | | | | | | | | | |
| 11 | Ink | centrifugal | 93-122 | 4.0 × 10⁴ | PET | *5 | *7 | *8 | *10 | Inv. |
| | Composition 7 | separation + TEFLON | | | | | | | | |
| | | 3 μm | | | | | | | | |
| 12 | Ink | centrifugal | 97-128 | 7.0 × 10⁴ | PET | *5 | *7 | *8 | *10 | Inv. |
| | Composition 8 | separation + TEFLON | | | | | | | | |
| | | 3 μm | | | | | | | | |
| 13 | Ink | centrifugal | 95-119 | 1.0 × 10⁵ | UPO FGS | *6 | *7 | *9 | *11 | Inv. |
| | Composition 9 | separation + TEFLON | | | | | | | | |
| | | 3 μm | | | | | | | | |
| 14 | Ink | CMF 10 μm | 102-130 | 2.0 × 10⁶ | UPO FGS | *6 | *7 | *9 | *11 | Comp. |
| | Composition 9 | | | | | | | | | |

*1: number of coarse particles of at least 1 μm of each color (number/μl)
*2: illuminance determined by UVPF-A1 produced by Iwasaki Electric Co.)
*4: maximum illuminance and peak wavelength on the surface of the recording material
*5: high pressure mercury lamp VZERO 085 (produced by Integration Technology)
*6: low pressure (Nippo exclusive product) 200 W power source
*7: 0.1 second after deposition of ink droplets
*8: FIG. 1 arrangement of lamp units on both sides of the recording head
*9: FIG. 2 exposure from linear light source down-stream in the recording material conveying direction
*10: 400 mW/cm² at 365 nm
*11: 160 mW/cm² at 254 nm
Com.: Comparative Example
Inv.: Present Invention

The materials in Table 3 are as follows:
UPO FGS: a product of UPO Co. (trade name)
PET: polyethylene terephthalate
   <<Evaluation of Ink-Jet Recording Images>>

Evaluations below were performed for each image recorded employing the above image recording method at an output of 1 m, 10 m, 50 m, and 100 m, and the resulting values were utilized to evaluate ejection stability.

(Evaluation of Character Quality)

Ming-cho type characters at 6-point were printed at the target density, employing each color of Y, M, C, and K, and character quality was evaluated based on the criteria below.
A: no jaggedness was noted
B: slight jaggedness was noted
C: jaggedness was noted, but characters were readable and at the lower commercial viability
D: marked jaggedness was noted and at such a level that characters were not readable due to blurring

Thus obtained evaluation results of Character Qualities are shown in Table 4.

TABLE 4

| Sample No. | At 1 m | At 10 m | At 50 m | At 100 m | Remarks |
|---|---|---|---|---|---|
| 1 | B | B | D | D | Comp. |
| 2-1 | A | B | B | C | Inv. |
| 2-2 | B | B | C | C | Inv. |
| 3-1 | B | C | D | D | Comp. |
| 3-2 | C | D | D | D | Comp. |
| 4 | A | A | B | B | Inv. |
| 5 | A | D | D | D | Comp. |
| 6 | A | B | C | D | Comp. |
| 7 | B | B | B | B | Inv. |
| 8 | B | D | D | D | Comp. |
| 9 | A | A | A | A | Inv. |
| 10 | A | B | D | D | Comp. |
| 11 | A | B | B | C | Inv. |
| 12 | B | B | C | C | Inv. |
| 13 | A | A | B | B | Inv. |
| 14 | C | D | D | D | Comp. |

Comp.: Comparative sample
Inv.: Inventive sample

It was shown that the constitutions of the present invention can very stably give images having high resolution.

What is claimed is:

1. An actinic ray curable ink-jet ink comprising a photoinitiator, a photopolymerizable composition, pigment particles, a dispersing agent having an amine value and an acid value, with the proviso that the amine value is larger than the acid value,
wherein the pigment particles has an average particle diameter of from 0.08 to 0.25 μm and a number of the pigment particles having a particle diameter of not less than 1 μm is less than 6.0×10⁵/μl, the particle diameter being measured with a dynamic light scattering method.

2. The actinic ray curable ink-jet ink of claim 1,
wherein the pigment particles are subjected to a surface treatment and a content of the dispersing agent is 35 to 65 weight % based on the total weight of the pigment particles.

3. The actinic ray curable ink-jet ink of claim 1,
wherein the photopolymerizable composition comprises an oxirane compound.

4. The actinic ray curable ink-jet ink of claim 1,
wherein the photopolymerizable composition comprises:
(a) an oxetane compound in an amount of 30 to 95 weight %;
(b) an oxirane compound in an amount of 5 to 70 weight %; and
(c) a vinyl ether compound in an amount of 0 to 40 weight %, each weight % of (a), (b) and (c) being based on the total weight of the photopolymerizable composition.

5. The actinic ray curable ink-jet ink of claim 1,
wherein the actinic ray curable ink-jet ink has a viscosity of 7 to 50 mPa·s at 25° C.

6. The actinic ray curable ink-jet ink of claim 1,
wherein the pigment has an amine value and an acid value, with the proviso that the amine value is larger than the acid value.

7. The actinic ray curable ink-jet ink of claim 1,
wherein a content of the pigment particles is 0.5 to 4.8 weight % based on the total weight of the actinic ray curable ink-jet ink.

8. A method of forming an image comprising the steps of:
ejecting droplets of the actinic ray curable ink-jet ink of claim 1 from a plurality of nozzles of an ink-jet recording head onto a recording material to form an image; and
irradiating the formed image with actinic rays to cure the image,
wherein the irradiating step is carried out between 0.001 and 1 second after the ejected droplets reach the recording material.

9. A method of forming an image comprising the steps of:
ejecting droplets of the actinic ray curable ink-jet ink of claim 1 from a plurality of nozzles of an ink-jet recording head onto a recording material to form an image; and
irradiating the formed image with actinic rays to cure the image, wherein a thickness of the cured image is in the range of 2 to 25 μm.

10. A method of forming an image comprising the steps of:
ejecting droplets of the actinic ray curable ink-jet ink of claim 1 from a plurality of nozzles of an ink-jet recording head onto a recording material to form an image; and
irradiating the formed image with actinic rays to cure the image,
wherein the droplets of the actinic ray curable ink-jet ink ejected from each nozzle of the ink-jet recording head have a volume of 2 to 15 pl.

11. A method of forming an image comprising the steps of:
ejecting droplets of the actinic ray curable ink-jet ink of claim 1 from a plurality of nozzles of an ink-jet recording head onto a recording material to form an image; and
irradiating the formed image with actinic rays to cure the image,
wherein the ink-jet recording head is a line head.

12. An ink-jet recording apparatus for carrying out the image forming method of claim 8,
wherein the actinic ray curable ink-jet ink and the ink-jet recording head are heated at 35 to 100° C. before ejecting the actinic ray curable ink-jet ink from a plurality of nozzles of the ink-jet recording head.

13. An ink-jet recording apparatus for carrying out the image forming method of claim 9,
wherein the actinic ray curable ink-jet ink and the ink-jet recording head are heated at 35 to 100° C. before ejecting the actinic ray curable ink-jet ink from a plurality of nozzles of the ink-jet recording head.

14. An ink-jet recording apparatus for carrying out the image forming method of claim 10,
wherein the actinic ray curable ink-jet ink and the ink-jet recording head are heated at 35 to 100° C. before ejecting the actinic ray curable ink-jet ink from a plurality of nozzles of the ink-jet recording head.

15. An ink-jet recording apparatus for carrying out the image forming method of claim 11,
wherein the actinic ray curable ink-jet ink and the ink-jet recording head are heated at 35 to 100° C. before ejecting the actinic ray curable ink-jet ink from a plurality of nozzles of the ink-jet recording head.
